(19) United States
(12) Patent Application Publication
(10) Pub. No.: US 2007/0213877 A1
(43) Pub. Date: Sep. 13, 2007

(54) Hand cleaning apparatus and method of use of same

(76) Inventors: Andrew J. Hart, Mississauga (CA); Geoffrey Roy Fernie, North York (CA)

Correspondence Address: BERESKIN AND PARR, 40 KING STREET WEST, BOX 401, TORONTO, ON, M5H 3Y2, CA

(21) Appl. No.: 11/371,931

(22) Filed: Mar. 10, 2006

(51) Int. Cl. B08B 7/04; G05D 7/00; G05D 11/00

(52) U.S. Cl. 700/282; 134/18

(57) ABSTRACT

An apparatus for providing control for the access to a building or a portion of a building based upon a user washing or disinfecting their hands comprises a hand cleaning apparatus and an output module wherein the output module controls the operation of automatic doors or provides an access card or an authorization badge, or any combination thereof, to permit entry to a building. A method of using the hand cleaning apparatus as part of a system to control entrance to a building is also provided. A method of using the hand cleaning apparatus as part of a system to control entrance to certain parts of a building only is also provided. A hand cleaning apparatus, and a method of use thereof, to check the health of a person or to dispense a mask and/or gloves is also provided.

### FIELD OF THE INVENTION

In one aspect, this invention relates to a hand cleaning or disinfecting apparatus that is used to control entry to a building, such as a hospital, a nursing home, a medical clinic or a public/government building. The hand cleaning apparatus may be provided with a dispenser for providing an access card or an authorization badge permitting entry into the building. Alternately, the hand cleaning apparatus may automatically control access to the building. Accordingly, the hand cleaning apparatus may be connected to a door control mechanism of the building, wherein, upon completion of the use of the hand cleaning apparatus, the apparatus provides a signal for the door of the building to open or to unlock. In another embodiment, the hand cleaning apparatus may be provided with a dispenser to provide gloves and/or mask to a user. In another embodiment, the hand cleaning apparatus may be provided with a sensor to check the health, e.g., temperature, of a user.

### BACKGROUND OF THE INVENTION

Washing and/or disinfecting hands is a safe guard against the spread of infection, whether in a health care institution, a long-term care building, a retirement home or any other building or location. The facilities which have been provided for hand washing in the past include standard basins and soap. During the SARS outbreak, facilities provided alcohol gel dispensers to be used to clean the hands of all visitors, but this proved largely ineffective because the amount of gel dispensed and the time to massage the gel into the hands was critical and rarely correct to clean/disinfect the hands. Temperature control was done manually and very labour intensive. However, more sophisticated apparatus have been developed. For example, U.S. Pat. Nos. 5,860,437 and 5,972,126 disclose an automated hand washing apparatus. As set out therein, the hand washing apparatus may comprise a self contained unit which can be operated by a user and which may be self cleaning, i.e. after use, the hand washing apparatus may clean itself.

As set out in the '473 and '126 patents, the hand washing apparatus may include a sensor (e.g. a magnetic card reader). Accordingly, the apparatus may keep track of the individuals who use the apparatus.

Patients in nursing homes are elderly and may be particularly susceptible to infection. Accordingly, during times of outbreak of infectious diseases, the entry of personnel to a nursing home may be restricted. Alternately, or in addition, medical facilities may require visitors or patients to first be checked by a medical practitioner to determine whether they are healthy prior to entering the building or to sterilize their hands, such as by applying an alcohol gel composition, e.g., Purell™, to their hands. One disadvantage with this approach is that it is highly labour intensive. Reliable personnel must be placed at each control point to or in a building, and it is very difficult to ensure that a correct hand washing/cleaning/disinfecting regimen was followed.

### SUMMARY OF THE INVENTION

In accordance with one aspect of the instant invention, a hand cleaning apparatus is provided which may be integrated into a system for controlling access to a building or a portion of a building. Accordingly, access to the building or the portion of the building would be permitted only subsequent to a person utilizing the hand cleaning apparatus. Accordingly, if a person does not use the hand cleaning apparatus, the person would not be permitted to enter the building. Once the person does use the hand cleaning apparatus, they may then be permitted entry into the building.

The hand cleaning apparatus may control entrance to the building in one of a number of ways. For example, the hand cleaning apparatus may have a dispenser incorporated into the structure of the hand cleaning apparatus itself. Alternately, a dispenser may be associated with the hand cleaning apparatus, e.g., the hand cleaning apparatus may send a signal to a dispenser in a separate housing after use of the hand cleaning apparatus by a person. Upon completion of use of the hand cleaning apparatus, the dispenser may be programmed to provide an access card to the person. The person may then utilize this access card to unlock a door, turnstile, or other barrier to entry. For example, the card could be a magnetically readable card or a proximity card. The card may be designed to be retained by the user while they are on the premises. Alternately, the card could be retained in a card reader such that the card could not subsequently be used by another party to gain access. The dispenser could be any mechanism known in the vending machine or building entry system arts and may include a printer to print the time and date when the card was dispensed.

Alternately, the dispenser could dispense an authorization badge. The badge would be worn or carried by a person to indicate that they have cleaned their hands and have been cleared for entrance to the building or a portion of the building. In such a case, the badge could be visually inspected at a point of entry and/or subsequently as a person travels through the building or the portion of the building. The badge could have the image of the person printed thereon and/or the time and date when the badge was dispensed.

Hands need to be re-cleaned after a period of time in the building. Accordingly, in accordance with alternate embodiment the badge could also have a signaling member, which may be auditory and/or visual, to signal a warning when the person needs to again clean their hands. For example, the signaling member may be LEDs or lights, or at least a portion of the badge could utilize electroluminescence to change colour, and a timer may be provided so as to flash or signal a warning after a predetermined time when the person again needs to clean their hands. The signaling member could be a small speaker to emit an auditory signal.

Alternately, the hand cleaning apparatus could send a signal to a person monitoring an entrance (e.g., at a security station by a door, or at a remote location wherein the person can remotely lock or unlock, or remotely open or close, a door). The signal could indicate that the person has cleaned their hands and, optionally, passed other requirements, such as a temperature scan, and should be permitted entry to the building or, alternately, that the person did not clean their hands, or showed an elevated body temperature and should not be permitted entry to the building. The hand cleaning apparatus could be under video surveillance, or the hand cleaning apparatus could have a camera built in, so that the person monitoring the door or entrance knows that the person approaching the door or entrance is the person who used the hand cleaning apparatus.

In another embodiment, the building or a portion of the building may be provided with doors or the like which are opened automatically by, e.g., a motor or compressor when a sensor detects that a person is approaching the door or pushes a button. Such systems are known in the art. In accordance with this embodiment, the hand cleaning apparatus may be operatively connected to the door entrance system so as to automatically open the door when a person has completed using the hand cleaning apparatus. For example, the hand cleaning apparatus may send a signal to a motor to actuate the motor, causing a door to open, once the hand cleaning apparatus has been used successfully. Alternately, the door operating system may be locked (i.e. the approach of a person will not result in the door opening). In such a case, the hand cleaning apparatus may provide a signal to the door operating system unlocking the doors so that the doors will open when a person approaches the doors.

One advantage of this embodiment of the invention is that the entrance to a building may be controlled automatically by a hand cleaning apparatus. Accordingly, the hand cleaning apparatus and any required systems (e.g. door operating systems) may be provided at each entrance to a building or at selected places throughout the building. Accordingly, access to or through a building may be controlled without the need to station personnel at all locations. Optionally, if desired, video surveillance equipment or the like may be provided so that a person in a control room may monitor the operation of the apparatus and/or each door and may be able to provide an override command preventing entrance (e.g. preventing a door from opening) if a person does not use the hand cleaning apparatus or does not properly use the hand cleaning apparatus (e.g. the person actuates the hand cleaning apparatus but do not place their hands under the water or gel).

Alternately, or in addition, the hand cleaning apparatus may include a hand cleaning sensor. The hand cleaning sensor is provided to detect whether a person properly uses the apparatus. For example, the hand cleaning sensor may comprise an optical sensor which is positioned to detect whether a person places their hands under the water and/or uses the soap dispenser which may be provided and/or applies an alcohol gel composition or the like. If the hand cleaning sensor does not detect proper usage of the equipment, then the hand cleaning sensor may provide a signal preventing the hand cleaning apparatus from dispensing a badge or access card and/or from permitting a door to the building to be opened.

Alternately, or in addition, the hand cleaning apparatus may also include a dispenser, or be linked to a dispenser, to dispense gloves and/or a mask. For example, once a person has cleaned their hands, they may be provided with a pair of gloves thereby ensuring that their hands do not become contaminated by subsequently touching a foreign object. Similarly, a mask may be provided to reduce the likelihood that the person will inhale or exhale any cotangen. Alternately, the person entering the building may be sick, but without an elevated body temperature which would allow them to successfully pass the hand cleaning apparatus. Accordingly, by using the mask and gloves, the person may reduce the likelihood that they will spread a cotangen in the building. Accordingly, in one embodiment, a hand cleaning apparatus may include or be associated with, a dispenser for gloves and/or a mask and may optionally also control entrance to a building or a portion of a building.

In a further alternate embodiment, the hand cleaning apparatus may include a health sensor. The health sensor is preferably a remote sensing unit to check to determine whether a person may be sick. Preferably, the health sensor comprises a sensor to remotely monitor the temperature of a person. In particular, apparatus to obtain the temperature of a person passing by a location are known and have been used in airports (e.g. during the SARS) outbreak. Such a sensor may be incorporated or associated with the hand cleaning apparatus. If the sensor determines that the person may be sick (e.g. the health sensor is a sensor that can detect from a distance if a person has an elevated temperature), then the hand cleaning apparatus could be programmed to prevent the person from entering the building (e.g. by not dispensing a badge and/or an access card and/or not permitting a door to be opened). Alternately, or in addition, the sensor could cause the apparatus to dispense gloves and/or a mask. Alternately, or in addition, a signal could be provided indicating that the person may be sick (an auditory signal or a flashing light). According to this embodiment, a person utilizing the apparatus could be checked automatically to determine whether they may be sick and, if they are, provided with a mask and/or gloves and advised to wait or not be permitted entry until appropriate personnel are alerted and are allowed to take action. Accordingly, in one embodiment, a hand cleaning apparatus may include or be associated with, a dispenser for gloves and/or a mask and a health sensor and may dispense gloves and/or a mask if the health sensor detects that the person using the hand cleaning apparatus may be sick.

In accordance with another embodiment, the apparatus may include an input member to obtain identifying information about the person using the apparatus. For example, the apparatus may be provided with a card reader (e.g. a proximity card reader or a magnetic card reader). Alternately, or in addition, a keyboard may be provided to permit a person to enter their name and optionally other identifying information (e.g. sex, age, address, telephone number, hospital identification card, government health card and the like). Some or all of this information could be provided on the badge and/or access card provided to the person. The information could be printed on the badge and/or access card or magnetically encoded thereon.

In one aspect of this invention, the access card or authorization badge may permit entry to only portions of the building. Alternately, the access card or authorization badge may permit entry to the building, or only portions of the building, for a limited period of time. This information may be obtained by the user entering the information into the hand cleaning apparatus or from a machine-readable security or identity card in the possession of the user. For example, if the user is an employee or an emergency medical worker (e.g. a paramedic), the user may show their identity or security card to the hand cleaning apparatus. The hand cleaning apparatus may be preprogrammed with the portion of the building to which the worker requires admittance for the purpose of their job and/or the period of time the worker requires access to the building for the purpose of their job (e.g. their work shift). If the user is a visitor, they may enter their destination into a keyboard or other data entry device and the hand cleaning apparatus may be programmed to be able to determine, or may be preprogrammed with, the portions of the building and/or the time period for which that person should be permitted entry to the building. For example, if the user is visiting a patient in a hospital, the user may be permitted to enter the portions of the building from the front door to the room of the patient and only for visiting hours.

Accordingly, the apparatus may be used as part of an integrated system to monitor the personnel who enter the building or a portion without the need of human supervision, or in combination with human supervision.

In accordance with other embodiments of this invention, it will be appreciated that the various units described above may be combined in various different sub-combinations. For example, in one alternate embodiment, the hand cleaning apparatus may be provided with a dispenser for gloves and the like but may not control access to the building. In a further alternate embodiment of the invention, the hand cleaning apparatus may be provided with a health sensor but need not control access to the building and need not dispense gloves and masks.

In a further alternate embodiment of the invention, the hand cleaning apparatus may issue the user with a badge on successful completion of the apparatus cycle(s) to be worn by the user, but not control access to the building.

In accordance with another aspect of this invention, the identity determination and badge/card dispensing functions may be provided in an apparatus, which does not have a hand cleaning feature which is used to control access to a hospital, a nursing home, or a medical clinic. In accordance with such an embodiment, an apparatus may have an input member to obtain identifying information about a person and an access card or authorization badge dispenser. The apparatus receives information about the person, which is preferably be the person who operates the apparatus if the apparatus is to be operated by the user (i.e., the person seeking admittance), and uses that information to provide an access card or authorization badge or the like that permits entry to the building or portion of the building to which the person requires admittance for the purpose of their job and/or the period of time the person requires access to the building for the purpose of their attendance (e.g., their job or to visit a person). The person may work in the hospital, nursing home, a or the medical clinic, and may have a machine readable security or identity card. The person may provide the card to the machine which determines, such as by means of a program and/or database, the portions of the building to which the person may have access and the duration they may be in those portions of the building. Alternately, the person may not be in the databank of the apparatus and may have to enter their information such as by means of a keyboard or other data entry device. Optionally, the apparatus may have a health sensor. If the person is sick, or deemed sick by the health scanner, they may be denied access to all or a portion of the building. Alternately, if the person works in the building, the portion they are admitted to may be limited if they are sick. For example, if the person is a nurse and the health sensor indicates they may be sick, the person may be issued a badge that would not include an authorize to enter a ward having patients who have AIDS or who have a weakened immune system.

It will be appreciated that the person who is seeking admittance preferably operates the hand cleaning apparatus. Therefore, the user is the person who operates the hand cleaning apparatus. Accordingly, a staff member need not operate the apparatus.

The hand cleaning apparatus may use any treatment method to clean the hands of a person. Preferably, the hand cleaning apparatus dispenses soap and water or an alcohol gel composition. However, any other technique known now or in the future to clean, and preferably sanitize, a person's hands may be used.

Accordingly, in accordance with one embodiment of this invention, there is provided an apparatus comprising:
(a) a hand cleaning apparatus;
(b) an output module enabling entry to a building or portion of a building; and,
(d) a controller connected to the hand cleaning sensor and the output module, the controller actuating the output module subsequent to activation of the hand cleaning apparatus.

In one embodiment, wherein the building is selected from the group consisting of a hospital, a nursing home, a medical clinic, a government building and a public building, the apparatus is positioned outside, or in the entrance to the building or the portion of the building and the output module is operatively connected to open or permit opening of a barrier to entry of the building or the portion of the building upon a positive signal being issued by the controller. For example, the barrier to entry may be a door and the output module may be operatively connected to open the door (e.g. to actuate a motor that is drivingly connected to the door). Alternately, the barrier to entry may be a turnstile, which may be locked (e.g., by the engagement of a locking member such as a rod or gear engaging a portion of the turnstile such as a recess or a gear), and the output module may be operatively connected to the turnstile to permit the turnstile to turn (e.g., by moving the locking member to a disengaged position as is known in the turnstile art).

In another embodiment, the output module provides a member upon a positive signal being issued by the controller.

In another embodiment, the member comprises an access card that is readable by a card reader and the card reader is operatively connected to open the barrier to entry of the building.

In another embodiment, the member comprises an authorization badge, which visually displays information.

In another embodiment, the output module includes a mask and/or glove dispenser, whereby upon a positive signal being issued by the controller, the output module dispenses one or both of gloves and a mask.

In another embodiment, the apparatus further comprises a signaling member whereby upon a negative signal being issued by the controller, the signaling member issues a warning signal to a user.

In another embodiment, the apparatus further comprises a signaling member whereby upon a negative signal being issued by the controller, the signaling member issues a warning signal to building security staff. This may be via a building security monitoring station or system.

In another embodiment, the apparatus further comprises a hand cleaning sensor and the controller actuates the output module upon receiving a positive signal from the hand cleaning sensor.

In another embodiment, the hand-cleaning sensor monitors the position of the hands of a user and, preferably, that the cleaning/cleaning and/or disinfecting cycle was completed according to the programming of the hand cleaning apparatus.

In another embodiment, the hand cleaning apparatus operates a cleaning cycle and the controller actuates the output module after completion of the cleaning cycle.

In another embodiment, the apparatus further comprises a health sensor to check the health of a user.

In another embodiment, the health sensor uses the temperature of a user to determine whether the user may be sick.

In another embodiment, the apparatus further comprises a signaling member wherein the health sensor causes the signaling member to issue a warning signal if the health sensor determines that a user may be sick.

In another embodiment, upon determining that a user may be sick, the health sensor sends a signal preventing the actuation of the output module.

In another embodiment, the apparatus further comprises an input member whereby a person enters identifying information.

In another embodiment, the input member comprises a card reader and/or a keyboard.

In another embodiment, the output module comprises an access card dispenser or an authorization badge dispenser and at least some of the identifying information is provided on an access card or authorization badge dispensed by the apparatus.

In another embodiment, the badge has a signaling member to signal a warning when a person needs to again clean their hands.

In another embodiment, the member is coded to authorize entrance to one or more portions of the building and/or to authorize entrance to a building or one or more portions of the building for a specified period of time.

In accordance with another embodiment of this invention, there is provided an apparatus comprising:
(a) a hand cleaning apparatus;
(b) a hand cleaning sensor; and,
(c) a mask and/or glove dispenser, whereby upon a positive signal being issued by the hand-cleaning sensor, the output module dispenses one or both of gloves and a mask.

In another embodiment, the apparatus further comprises a signaling member whereby upon a negative signal being issued by the hand-cleaning sensor, the signaling member issues a warning signal to a user.

In another embodiment, the apparatus further comprises a health sensor to check the health of a user.

In another embodiment, the health sensor uses the temperature of a user to determine whether the user may be sick.

In accordance with another embodiment of this invention, there is provided an apparatus comprising:
(a) a hand cleaning apparatus;
(b) a hand cleaning sensor; and,
(c) a health sensor to check the health of a user.

In one embodiment, the apparatus further comprises a signaling member whereby upon a negative signal being issued by the hand-cleaning sensor, the signaling member issues a warning signal to a user.

In another embodiment, the apparatus further comprises a signaling member whereby upon a negative signal being issued by the health sensor, the signaling member issues a warning signal to building security staff. This may be via a building security monitoring station or system.

In another embodiment, the health sensor uses the temperature of a user to determine whether the user may be sick.

In accordance with another embodiment of this invention, there is provided a method for controlling access to a building or a portion of a building using a hand cleaning apparatus, the method comprising:
(a) positioning the hand cleaning apparatus proximate to a barrier to entry of a building or the portion of the building; and,
(b) using a dispenser apparatus to automatically provide one or more of an access card and an authorization badge to a person after the hand cleaning apparatus is actuated.

In one embodiment, the building or the portion of the building has a barrier to entry that is controlled by a card reader and the method further comprises using the access card to open the barrier to entry.

In another embodiment, the method further comprises requiring the person to show the authorization badge prior to entering the building or the portion of the building.

In another embodiment, the method further comprises providing a health sensor that automatically checks the health of a person and preventing the person from entering the building or the portion of the building if the health sensor determines that the person may be sick.

In another embodiment, the method further comprises providing a mask and/or glove dispenser, whereby mask and/or glove dispenser dispenses one or both of gloves and a mask after the person uses the hand cleaning apparatus.

In another embodiment, the method further comprises requiring the person to enter identifying information prior to the dispenser operating.

In another embodiment, at least some of the identifying information is provided on the card or badge dispensed by the dispenser.

In accordance with another embodiment of this invention, there is provided a method for controlling access to a building or a portion of a building using a hand cleaning apparatus wherein the building or the portion of the building has a barrier to entry that is mechanically controlled, such as by a motor, the method comprising:
(a) positioning the hand cleaning apparatus proximate to the barrier to entry of the building or the portion of the building; and,
(b) operatively connecting the hand cleaning apparatus to the barrier to entry whereby the barrier to entry is configured to permit entry after the person uses the hand cleaning apparatus.

In one embodiment, the method further comprises providing a health sensor that automatically checks the health of a person and preventing the person from entering the building or the portion of the building if the health sensor determines that the person may be sick.

In another embodiment, the method further comprises providing a mask and/or glove dispenser, whereby mask and/or glove dispenser dispenses one or both of gloves and a mask after the person uses the hand cleaning apparatus.

In another embodiment, the method further comprises requiring the person to enter identifying information prior to the dispenser operating.

In another embodiment, the method further comprises providing one or more of an access card and an authorization badge to the person after the person uses the hand cleaning apparatus.

In another embodiment, at least some of the identifying information is provided on the card or badge provided to the person.

### BRIEF DESCRIPTION OF THE DRAWINGS

These and other advantages of the instant invention will be more fully and completely understood in accordance with the following drawings of preferred embodiments of the invention in which:

FIG. 1 is a perspective view of a building having a hand cleaning apparatus positioned outside a door and linked to a door entry system;

FIG. 2 is a perspective view of a person using the hand cleaning apparatus of FIG. 1;

FIG. 3 is a perspective view of a person using an alternate embodiment of the hand cleaning apparatus of FIG. 1;

FIG. 4 is a perspective view of a further alternate hand cleaning apparatus according to an embodiment of this invention.

FIG. 5 is a front elevational view of a hand cleaning apparatus in accordance with one embodiment of this invention with the front removed so as to show various parts of the interior;

FIG. 6 is a side elevational view partially in section showing the hand cleaning apparatus of FIG. 5 in the hand cleaning position;

FIG. 7 is an enlarged sectional view corresponding to FIG. 6 showing the bowl portion rotated inwardly for rinsing and disinfection;

FIG. 8 is an enlarged front elevational view of the bowl with the bowl rotated to its hand cleaning position;

FIG. 9 is a plumbing diagram of the hand cleaning apparatus of FIG. 5 showing the water or gel inflow and outflow routing;

FIG. 10 is an electrical blocked diagram showing the basic controls, and their relation to an optional foot switch, of one embodiment of the hand cleaning apparatus; and,

FIG. 11 is a perspective view of an alternate embodiment of a hand cleaning apparatus positioned outside a door to control access through the door.

### DETAILED DESCRIPTION OF THE INVENTION

The method and apparatus of the instant invention may be used in conjunction with any hand cleaning apparatus known in the art. The hand cleaning apparatus has a member or members to permit a user to clean their hands such as by washing with soap or by using a disinfectant or sterilization agent such as an alcohol gel composition; and preferably drying their hands if soap and water are used. Any such apparatus known in the art may be used and is referred to herein as a hand cleaning apparatus. The hand cleaning apparatus may have an enclosure into which a person places their hands. See for example, U.S. Pat. No. 4,817,651. Alternately, the hand cleaning apparatus may have an externally positioned, or positionable, bowl that is used for hand cleaning. See for example, U.S. Pat. No. 5,972,126.

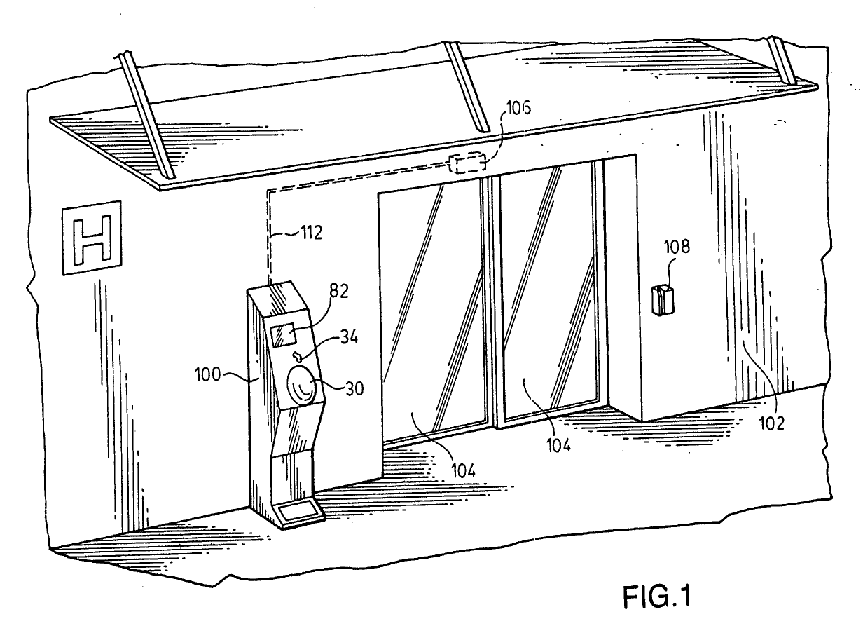

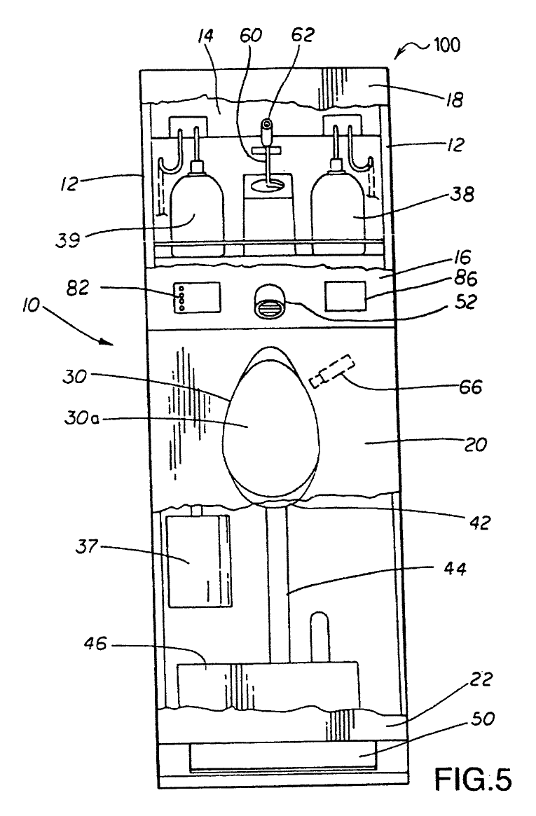

By way of example, a hand cleaning apparatus, which has an externally positionable bowl that is used for hand cleaning and that may be used in accordance with this invention, is exemplified in FIGS. 5-10. As exemplified in FIGS. 1-4, the hand cleaning apparatus has had incorporated into it various features which may be utilized singly or in combination or sub-combinations in accordance with this invention, including an access card dispenser, a badge dispenser, a mask and/or glove dispenser, a temperature sensor and a hand cleaning sensor.

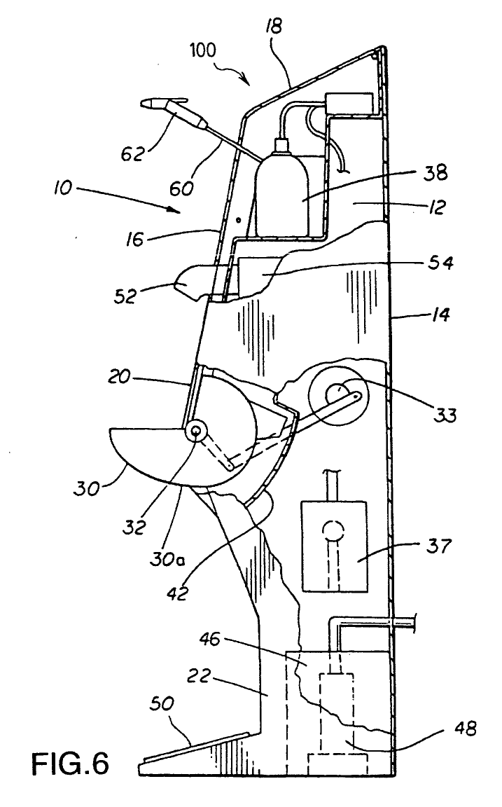

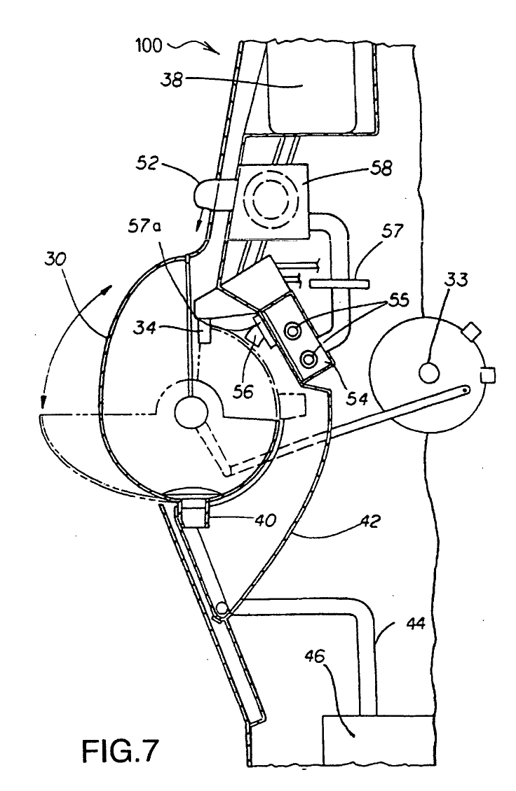

As exemplified in FIGS. 6 and 7, hand cleaning apparatus 100 comprises a generally rectangular upright housing 10 having sidewalls 12 and a back wall 14. A contoured front wall 16 defines a roof 18, and forwardly projecting cleaning region 20. A recessed foot region 22 is preferably provided at the lower end of front wall 16.

Within the front wall 16, on suitable framework, the details of which are omitted for the sake of clarity, there is a hand cleaning bowl indicated generally as 30. Bowl 30 is reconfigurable between an open or hand cleaning configuration, in which the bowl is configured for a user to wash their hands, and a closed configuration, in which bowl 30 may be cleaned after use. Preferably, bowl 30 is moveable between an open position in which the bowl is positioned for a user to wash their hands and a closed position in which bowl 30 may be cleaned after use. Alternately, the bowl 30 could be stationary and have a cover, which moves to cover or uncover the bowl.

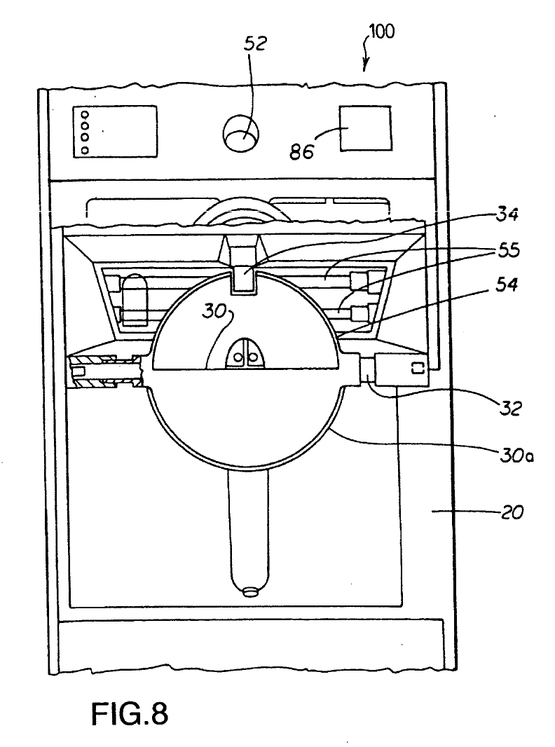

Bowl 30 may be moved between the open and closed positions by any means known in the art. Preferably, bowl 30 is pivotally mounted along a generally horizontal pivot axis by means of bearings 32. In this way, the bowl or sink 30 can be rotated to open outwardly for cleaning (FIGS. 6 and 8) and rearwardly into a covered inactive position for rinsing and disinfecting (FIG. 7) by suitable motor and crank means 33. While the bowl is described as being rotatably mounted, other forms of moveable mounting are possible. Thus, the bowl could simply slide in and out. Preferably, bowl 30 is mounted so that, when it is in the hand washing position, it is mounted at a suitable height for a user to wash their hands.

It will be appreciated by those skilled in the art that bowl 30 may be of any particular shape and that the actual shape of bowl 30 may vary depending upon whether bowl 30 is movably mounted and, if so, how it moves. For example, if bowl 30 is pivotally mounted, then bowl 30 is preferably of a generally semi-spherical shape. Thus, when rotated rearwardly to the closed position (FIG. 7), the underside of 30a of the bowl presents a smooth generally convex appearance, effectively closing and sealing the interior of the entire apparatus and preventing contamination by garbage or debris or personal contamination. Alternately, if bowl 30 is slideably mounted so as to slide in and out, then bowl 30 may be cylindrical or rectangular in cross section.

Located to one side of the bowl, within the interior enclosed by front wall 16, is a treatment fluid outlet which is preferably a water or gel outlet indicated generally as 34. Nozzle 34 is positioned to direct water or gel, preferably at a median temperature suitable for hand washing, if soap and water is used, into bowl 30 for wetting of the hands. Water or gel may be supplied to nozzle 34 by a pump (not shown), or simply by using the main's water pressure through a pressure regulator.

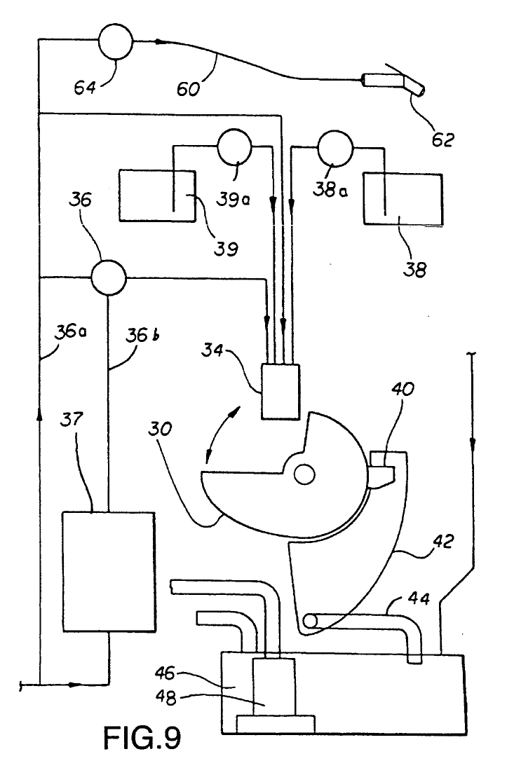

A cleaner, e.g. soap, is supplied for cleaning. The cleaner may be dispensed by passing the water through a suitable water/cleaner mixing valve 36 upstream from nozzle 34 (see for example FIG. 9). Accordingly, valve 36 may be connected to a supply of cold water via conduit 36a and connected to a water heater 37 contained within the apparatus via conduit 36b, and preferably controllable so as to supply a warm water mix at an appropriate temperature for washing hands. Pursuant to this embodiment, there is provided a container 38 for storing a cleaner for use when a user washes or rinses their hands. A plurality of such containers may be provided, each of which may contain a different cleaning compound. For example, as shown in FIG. 5, a soap container 38 and a disinfectant liquid material tank 39 are connected to the nozzle 34. The container or containers may thus supply a soap or gel, disinfectant or the like to the valve 36 for mixing with the water preferably at an appropriate concentration of cleaner to water.

Alternately, if the cold water supply is at a suitable temperature, then hot water heater 37 will not be required. Instead, the cold water supply may be fed directly to mixing valve 36 without combining the cold water with any heated water. This approach may also be used if a hot water supply and a cold water supply are first connected to a mixing valve and the mixing valve is then connected to the inlet water port for housing 10 (not shown).

Alternately, the cleaner, e.g., an alcohol gel composition, may be dispensed by a dispenser directly onto the hands of the user, preferably without the user using their hands to operate the dispenser. For example, the dispenser could be actuated by an optical sensor or by a remote actuator, eg. a foot pedal (not shown). According to this embodiment, the user may place their hands below the dispenser at which time the optical sensor will sense the presence of the user's hands thereunder and dispense an aliquot of cleaner or at which time the user may actuate the foot pedal. A plurality of dispensers, each with an associated actuator, may be provided.

If bowl 30 is rotatably mounted, it preferably has a rearwardly directed drain spout 40, for discharge of its contents, when it is rotated to the closed position. If bowl 30 is slideably or fixedly mounted, then drain spout 40 may be positioned at the lowest point of bowl 30 when bowl 30 is in use.

In order to catch the wash water, residue and any disinfectant from bowl 30, bowl 30 may be preferably mounted over a sink 42, which is fixed within the interior of front wall 16, and is connected by a conventional plumbing waste pipe 44 to a sump 46. In this way, when bowl 30 is rotated rearwardly, it will dump all of its contents through spout 40 into sink 42 and down the waste pipe 44. It will be appreciated that if bowl 30 is not rotatably mounted, it may be directly connected to waste pipe 44.

The water mixer 36, soap container 38 and disinfectant container 39 and their pumps 38a, 39a may be connected through a suitable timing mechanism (e.g. controller 70) so as to provide a timed operation for cleaning, for example, an initially wetting of the hand, followed by a soaping of the hands, followed by a rinsing of the hands in warm rinse water. At the end of the cycle, the washer may be automatically reconfigured to the closed position, such as by bowl 30 rotating rearwardly. It will be appreciated that alternate cleaning cycles may be preprogrammed. The user may select a desired cycle before use by pushing a button or by tripping an optical sensor (not shown). The different cycles may employ different chemical mixtures and/or may use shorter or longer periods of washing and/or rinsing. For example, there may be a quick rinse cycle when a full wash is not required. It will also be appreciated that the wash cycle may be manually controlled. For example, by a series of foot pedals or a series of optical sensors.

After washing, the washing bowl 30 is then preferably cleaned by water such as cold water which is supplied to the mixing valve 36 by the mains, receiving cold water from the conventional cold water supply together with a disinfectant, for cleaning and cleaning the bowl. Hot water could be used if desired. The cleaning mixture will drain out of bowl 30 through spout 40 and into sink 42. The bowl may then be dried by air being drawn from outside. The air may be sterilized through the UV air disinfecting chamber 54 and filter 57.

It is preferred that the apparatus is operable without the user's hands contacting the apparatus once the cleaning cycle commences. For example, the operation of the washer could be actuated by a user pushing a start button or by a user inserting coins into a coin fed actuator as is known in the vending machine industry (not shown). Alternately, hand cleaning apparatus 100 may be actuated by permitting hand cleaning apparatus 100 to read a machine readable card, such as by inserting a magnetic security card in a magnetic card reader, or a person entering identifying information, such as by a key board or other data entry device known in the arts. More preferably, the entire cycle of the machine, including the reconfiguration of bowl 30 and its cover, is actuated without the user's hands touching any of the controls. For example, the entire operation of bowl 30 and the water and soap dispenser, or gel dispenser, may be initiated by means of an actuator, such as a foot operated pedal 50 (FIG. 5) or an optical sensor or a proximity sensor keyed to a security card (not shown) so that the user's hands do not touch any of the controls after the cleaning cycle commences.

In order to dry the user's hands, a hot air dryer nozzle 52 is preferably provided (FIG. 5). Hot air nozzle 52 may be provided to supply heated and, preferably, heated and disinfected air. For this purpose, an air disinfecting chamber 54 may be provided with, for example, ultraviolet light tube 55 (see FIG. 7). Air may be drawn inwardly through nozzle 56 then through a suitable filter 57 and heater and fan 58 before exiting at the nozzle 52. Preferably, nozzle 56 may also be provided with filter 57a to prevent contaminants from entering, or reduce the contaminants entering, nozzle 56. By providing filter 57a for nozzle 56, the surface of filter 57a may be positioned so as to be exposed to the ultraviolet light emanating from ultraviolet light tube 55 thus helping to reduce the contamination of filter 57a. Nozzle 52 and a fan (not shown) are preferably timed (e.g., by controller 70) to supply sufficient hot air for the drying of the hands after rinsing. The drying cycle may, alternately be controlled by an optical sensor as is known in the art. In this way, not only are the hands thoroughly cleaned and washed without contact with any part of apparatus, but they are also dried by disinfected air.

When bowl 30 rotates rearwardly, it may then be rinsed, disinfected and dried. To this end, the air that is drawn through nozzle 56 may first be drawn around bowl 30 rendering it dry and clean for the next user. If desired, this drying air could also be disinfected and/or heated. Alternately, air from hot air nozzle 52 may be used to dry bowl 30.

From time to time, it may be desirable for service personnel to wash down the entire unit. For this purpose, a flexible hose 60 may be provided (see FIG. 6). Flexible hose 60 preferably has a manually operable jet nozzle 62 and is connected to the water supply within the apparatus, such as through a suitable valve 64 designed to be operable only by the service personnel so as to prevent vandalism and abuse.

As shown in FIG. 5, the device preferably includes a safety feature, namely optical sensor 66, which senses the presence of a person's hands in the vicinity of bowl 30 when it is open. This optical sensor prevents reverse rotation of bowl 30 so long as the person's hand are still in the vicinity of bowl 30, thereby preventing possible injury. It may also include a light to illuminate the hands so that a person can check for cleanliness.

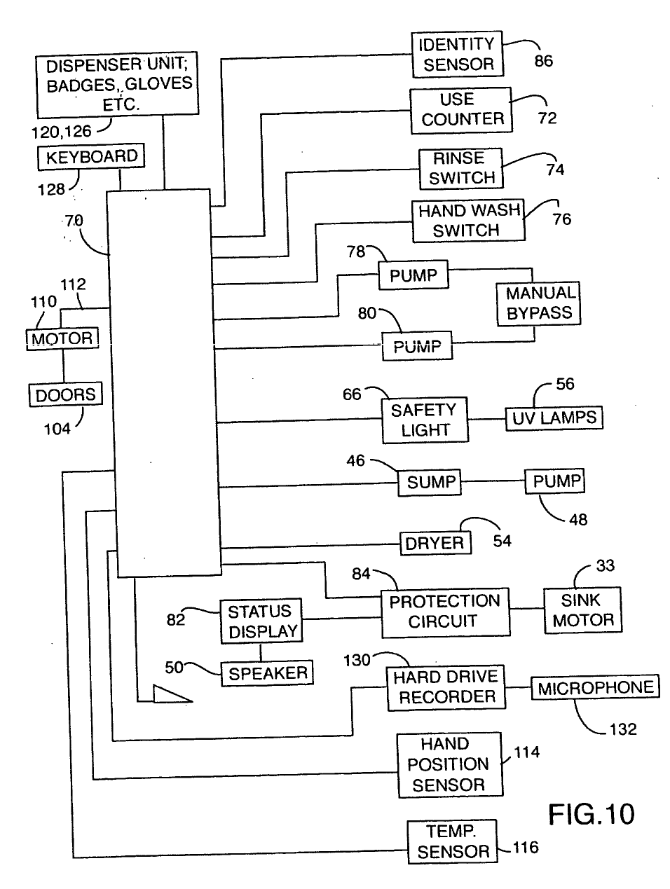

It will of course be appreciated that there are a large number of detailed electrical connections and controls and valves and relays. Reference to the plumbing diagram FIG. 9 and block diagram FIG. 10 will clarify the operation of a preferred version of the apparatus, and be a sufficient explanation for persons skilled in the art to understand the design and construction of a hand cleaning apparatus 100 which may be used in accordance with the instant invention.

As shown in FIG. 10, a main controller 70, which may be operated by, e.g., foot switch 50, may be connected to a use counter 72, a rinse switch 74 and a hand wash solenoid 76. It may also be connected to two pumps 78 and 80 and to a bowl operation protection device 66 already referred to and the ultraviolet light tube 56, and to the dryer operation 54.

With the sump reservoir 46, a pump 48 is preferably provided to periodically empty the sump. The reservoir can also be connected to the main plumbing drainage if desired.

Optional status display 82 may be connected to the controller via the protection circuit 84, so as to provide a visible display of the operative status of the apparatus.

The operation of the whole apparatus is self-evident from the foregoing description. In the preferred embodiment of FIGS. 5-8, in the storage position, bowl 30 is normally positioned rotated rearwardly so that the hemispherical underside of the bowl is directed outwardly, thereby rendering the entire apparatus secure, and sealed all around the bowl. A user wishing to use the apparatus will first of all operate the foot control, and the following preferred sequence of operations may then be started as follows, if soap and water is used:
A. Bowl 30 rotates to the open position.
B. Clean water at the controlled temperature is dispensed over the hands to wet the hands prior to the washing step.
C. A cleansing solution of water and soap or other disinfectant or cleaner is then mixed with the water and then dispensed over the hands so that the hands may be washed.
D. A rinsing solution of water at the controlled temperature is then dispensed over the hands so that the hand may be rinsed clean.
E. The hands are then withdrawn from the bowl and bowl 30 rotates closed, dumping the washing water into the sink 42, where it flows under gravity to the sump tank. Prior to the withdrawal of the hands from bowl 30, the bowl is prevented from closing inadvertently by the optical sensor.
F. A hot-air jet is then directed over the hands, having been first of all passed through the ultraviolet chamber to disinfect the air.
G. Water and a disinfectant mixture is then sprayed around the interior of the bowl, while it is closed, to disinfect the interior of the bowl. Air is drawn in around the bowl to dry it. This may be the air drawn in to feed the hot-air jet. In some cases, this air may be first disinfected and heated.

The following preferred sequence of operations may be started as follows, if a gel is used:
A. Bowl 30 rotates to the open position.
B. Gel is then dispensed over the hands so that the hands may be cleaned/disinfected.
C. The hands are then withdrawn from the bowl and bowl 30 rotates closed, dumping any excess gel into the sink 42, where it flows under gravity to the sump tank. Prior to the withdrawal of the hands from bowl 30, the bowl is prevented from closing inadvertently by the optical sensor.
D. Water and a disinfectant mixture may then be sprayed around the interior of the bowl, while it is closed, to disinfect the interior of the bowl. Air is drawn in around the bowl to dry it. This may be the air drawn in to feed the hot-air jet. In some cases, this air may be first disinfected and heated.

If desired, air, either hot or cold, can be directed around the side areas of the front panel on the side of the bowl, the sink and also around the floor next to the foot pedal to dry any moisture that may have escaped. It will be appreciated that if gel is dispensed, only an enclosure sized to receive a user's hands may be provided. Accordingly, the enclosure may not have any moving parts.

The counter 72 will record usage. In a more preferred embodiment, the device may also include a sensor 86 so as to identify the actual user. Thus counter 72 may identify the actual user, the actual cleaning cycles activated by the user and the time when the user used the washer cleaner. Sensor 86 may be any type that is known in the art. For example, sensor 86 may be adapted to identify a user by the security badge that the user might otherwise carry. For example, sensor 86 may be adapted to read a magnetic strip on a magnetic card 87 or a proximity card. Thus, in order to be able to activate the unit, the user must first swipe their card through sensor 86 and then proceed as described above. Alternately, sensor 86 may be of the proximity sensor type so that by placing the security badge near sensor 86, it will identify the user, or it may include a bar code reader to read a bar code affixed, for example, to a security badge.

After an appropriate count of uses, maintenance personnel may then check the apparatus, clean it and wash it down, and refill the various containers.

The apparatus will be seen to provide an effective disinfecting means of cleaning hands, preferably without the user's hands contacting any contaminants once the cleaning cycle commences as the cleaning water or gel is operated automatically without manual control, the soap dispenser is operated automatically without manual control and the bowl itself may be cleansed and disinfected between each usage after which the user's hands may be dried by disinfected hot air if soap and water was used. The whole operation as far as the user is concerned may be controlled by means of a foot pedal or the like thereby removing further sources of contamination common to conventional hand cleaning facilities.

The controlling of a cleaning cycle may be designed to meet various codes, such as FDA requirements. The sequence of events, the timing and duration, temperatures, the solution mixes, the cleaning of the bowl, the drying of the hands, as well as recording the successful completion of this sequence may be preprogrammed.

It will be appreciated that hand cleaning apparatus 100 may have a much simpler design. For example, it may comprise an alcohol gel dispenser, which may optionally be accessed after a start button is depressed or identifying information is provided (not shown). The dispenser may be provided in an open hollow chamber to protect the dispenser from the elements. Alternately a door may be provided to close the chamber, which is preferably automatically actuated. The chamber may be sized to only hold the dispenser or to provide an enclosure sized to permit a person to rub an alcohol gel composition over their hands.

Referring to FIG. 1, a preferred embodiment of the instant invention is exemplified wherein hand cleaning apparatus 100, such as the one embodied in FIGS. 5-8, is utilized to control access to a building, or a portion of a building.

Building 102 may have an entrance with doors 104, which are controlled by a door operating system (not shown). The door operating system may be any system known in the art. For example, the door operating system may comprise a proximity sensor 106 which is operatively connected to motor 110 which is connected via a suitable linkage to doors 104. Accordingly, doors 104 will open when proximity sensor 106 sends a signal to motor 110. The door operating system may alternately be operated by a weight sensor positioned in front of doors 104, a card reader, such as magnetic card 108, any other means known in the art, or any combination thereof.

In accordance with one embodiment of this invention, doors 104 will not open until a signal is provided by hand cleaning apparatus 100. Accordingly, if a person approaches doors 104 without first using hand cleaning apparatus 100, doors 104 will not open as a permissive signal has not been issued from hand cleaning apparatus 100. In accordance with this embodiment, upon actuation of hand cleaning apparatus 100 and, preferably, upon completion of a hand cleaning cycle, controller 70 may send a signal to the door operating system (e.g. via wire 112) permitting proximity sensor 106 and/or magnetic card reader 108 or the like to be actuated to send a signal to motor 110 when a person approaches door 104. For example, proximity sensor 106 and/or magnetic card reader 108 may be deactivated until a permissive signal is issued by controller 70. Alternately, or in addition, doors 104 may be mechanically locked. The permissive signal may actuate, e.g., a solenoid to open the lock, thereby permitting the doors 104 to be opened. Accordingly, it will be appreciated that any particular door 104 whether interior of a building or at an entrance to a building, may be locked and automatically opened only after a person has utilized hand cleaning apparatus 100.

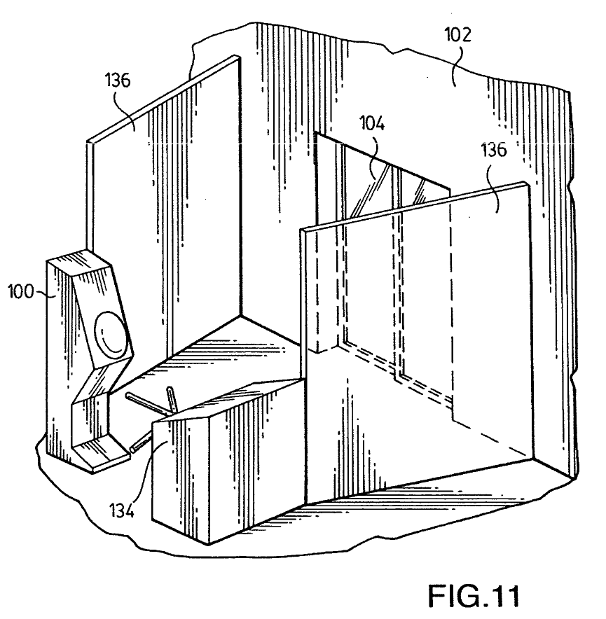

It will be appreciated that the entrance may be protected by a turnstile 134 or other entrance controlling member known in the arts (see, e.g., FIG. 11). A fence 136 or the like may be provided to prevent people from accessing door 104 without passing through turnstile 134. In an alternate embodiment, turnstile 134 may be positioned immediately adjacent door 104 so that a fence 136 is not required. Each of these may be automatically actuated or unlocked by the approach of a person provided a permissive signal has been given by hand cleaning apparatus 100.

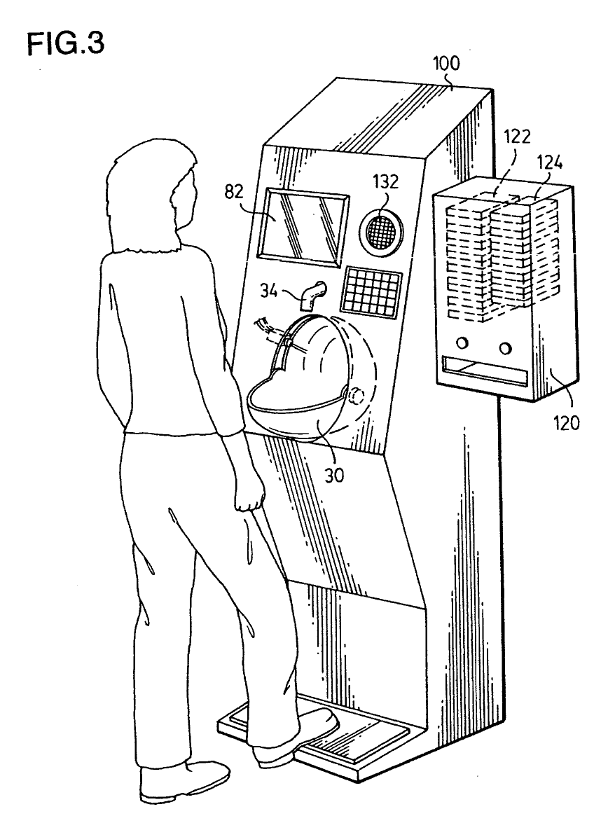

Alternately to controlling doors 104, or in addition, as exemplified in FIG. 3, hand cleaning apparatus 100 may be provided with or associated with dispenser 120 (e.g. dispenser 120 may be positioned external to hand cleaning apparatus 100 but connected to hand cleaning apparatus 100). Accordingly, on completion of a cleaning cycle, controller 70 may send a signal to dispenser 120 instructing dispenser 120 to dispense a member, e.g., an access card and/or an authorization badge.

Accordingly, dispenser 120 may be programmed to provide an authorization badge upon completion of a hand cleaning cycle. According to this embodiment, the building may require a person to wear the authorization badge at all times when they are in the building and/or only to display the badge to obtain entry to the building. For example, a person (e.g. a security guard) may be stationed adjacent to an entrance. The user would be required to display the authorization badge in order to gain access to the building or a portion of the building.

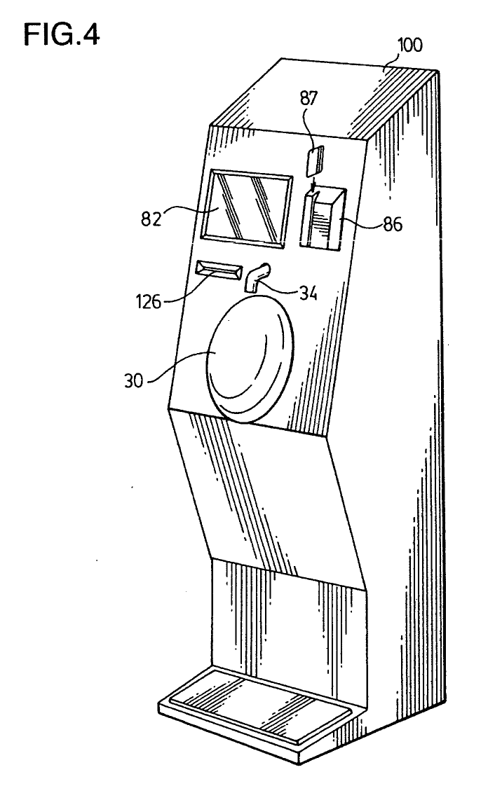

In accordance with a further alternate embodiment of this invention, as exemplified in FIG. 4, hand cleaning apparatus 100 may also incorporate or have associated therewith an access card dispenser 126 (e.g. access card dispenser 126 may be positioned external to hand cleaning apparatus 100 but connected to hand cleaning apparatus 100). Access card dispenser 126 may dispense an access card upon completion of a hand cleaning cycle. The access card issued by dispenser 126 may be a magnetic card, such as may be used with magnetic card reader 108, a proximity card or the like. Accordingly, upon completion of a hand cleaning cycle, the person may take the access card from dispenser 126 and utilize the card to enter the building. The user may retain the card (such as if a magnetic card reader 108 is utilized). Alternately, the access card may be retained by the reader (such as devices which are known to be used in turnstiles or the like).

Accordingly, whether a permissive signal is issued, or an access card or an authorization badge is dispensed, the hand cleaning apparatus 100 is used to control access to a building or a portion of a building. If hand cleaning apparatus 100 is positioned inside a building, it may control entry to one or more rooms. If hand cleaning apparatus 100 is positioned outside the building, it may control access to the entire building, or only a portion thereof. Hand cleaning apparatus 100 may be positioned with respect to an entrance so that only the person who uses hand cleaning apparatus 100 may pass through a door (e.g., as exemplified in FIG. 11, by positioning hand cleaning apparatus 100 at the entrance and having the door as part of the hand cleaning apparatus 100 so that hand cleaning apparatus 100 is configured as part of the entranceway). Alternately, a person may be used, whether physically present or by video surveillance, to ensure that the person who passes through an entrance is the one who used the hand cleaning apparatus 100.

Preferably, hand cleaning apparatus 100 is also provided with a hand cleaning sensor or hand position sensor 114. Sensor 114 may be any sensor known in the art that will monitor the use of hand cleaning apparatus 100 by a person to ensure that hand cleaning apparatus 110 is used by a person. For example, sensor 114 may be an optical sensor positioned to monitor the hands of a person beneath nozzle 34. Accordingly, if a person's hands are not beneath nozzle 34 during the hand cleaning cycle, sensor 114 may send a signal to controller 70 indicative that the person using the hand cleaning apparatus did not properly use the hand cleaning apparatus (i.e. they did not use the water and soap provided by hand cleaning apparatus 104 to wash their hands). Accordingly, e.g., controller 70 will not send a signal to motor 110 at the end of a hand cleaning cycle. It will be appreciated that optical sensor is preferably positioned beneath nozzle 34 and may be any sensor known in the plumbing art to actuate the flow of water when a person places their hands beneath a tap. It will also be appreciated that sensor 114 may alternately be a sensor and a imager whereby the imager provides a light beam or other signal which is broken (interrupted) by a person correctly positioning their hands in bowl 30 or under a dispenser.

In accordance with another embodiment of this invention, hand cleaning apparatus 100 may be provided with a health sensor 116. Health sensor 116 may be provided as part of hand cleaning apparatus 100 or may be associated therewith (e.g. it may be positioned external to hand cleaning apparatus 100 but connected to controller 70). Health sensor 116 may be any sensor known in the art which may be used to check to determine whether a person is sick. Preferably, health sensor 116 comprises a temperature sensor and, more preferably, a temperature sensor which is capable of detecting the temperature of a person (e.g. their face) remotely (i.e., without contacting the person). Such sensors have been developed in the art and any such sensor may be used herewith. In particular, sensors such as those which have been distributed at airports to check the health of persons passing through an airport during the SARS outbreak may be used. In accordance with this embodiment of the invention, if sensor 116 determines that a person may be sick, then sensor 116 may send a signal to controller 70 thereby preventing controller 70 from sending a signal to motor 110 upon completion of a hand cleaning cycle, or preventing dispensers 120, 126 from operating. Accordingly, despite using hand cleaning apparatus 100, a person may be prevented from entering building 102. In addition, a warning signal, such as an auditory signal issued by speaker 118 and/or a flashing light, may be emitted alerting, e.g., building security personnel in the area that a person may be sick, or the warning signal could be sent to the building security monitoring station.

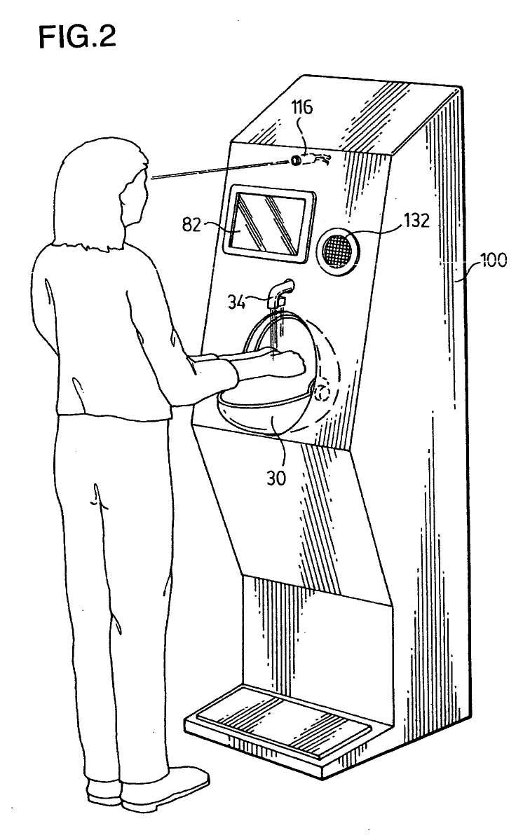

In a further alternate embodiment, as exemplified in FIG. 2, it will be appreciated that hand cleaning apparatus 100 need not be integrated into the door operating system but may be a stand alone unit positioned at any particular location outside or inside a building. According to such an embodiment, hand cleaning apparatus 100 incorporates health sensor 116 and optionally a warning device such as speaker 50 but need not be connected to the door operating system. In addition, display screen 82 may provide information to a person indicating that they may be sick and provide them with instructions.

In accordance with a further alternate embodiment, as exemplified in FIG. 3 dispenser 120 may be configured to dispense a mask 122 and/or gloves 124 in addition to, or in lieu of, an authorization badge or an access card. Accordingly, on completion of a cleaning cycle, controller 70 may send a signal to dispenser 120 instructing dispenser 120 to dispense a mask 122 and/or gloves 124. Accordingly, once a person has washed their hands, they may put on gloves 124 and/or mask 122.

In a further alternate embodiment, the hand cleaning apparatus exemplified in FIG. 3 may include health sensor 116. If health sensor 116 determines that the person may be sick, then dispenser 120 may be commanded via controller 70 to dispense a mask 122 and/or gloves 124 to the person. Hand cleaning apparatus 100 may issue a warning signal, if so equipped, and, if part of a door entry system, may prevent entrance to a building or portion of a building and may, if so equipped, provide instructions to the user. At the end of a hand cleaning cycle, if health sensor 116 determines that the person is not sick, then dispenser 120 may be commanded via controller 70 to dispense a mask 122 and/or gloves 124 to the person and, if part of a door entry system, may permit entrance to a building or portion of a building and may, if so equipped, provide instructions to the user.

Accordingly, in accordance with some embodiments of this invention, hand cleaning apparatus 100 is provided with an output module. The output module may be one or more of a member to provide a signal to a door operating system, an access card dispenser 126, an authorization badge dispenser 120 and a mask and/or glove dispenser 120. Regardless of the identity of the output module, the hand cleaning apparatus in combination with the output module can be used to control access to a building and/or to ensure that a person who enters a building is provided with a mask and/or glove.

In accordance with a further alternate embodiment of this invention, hand cleaning apparatus 100 may be provided with an input member to permit a person to enter identifying information (e.g. the person's name, address, phone number etc.). The input member may be designed to record any required information that may be selected for a building. Input member may be a card reader to read information provided on a security or identity card provided to a person working at the building (e.g. magnetic card reader 86 or a proximity card reader), a key pad 128 which may be a separate key pad or incorporated as part of status display 82 (e.g., display 82 may incorporate a touch sensitive screen depicting a keyboard), or a hard drive recorder 130 which receives input from microphone 132 or other input device known in the art. Some or all of this information may be contained on the access card or badge, which is dispensed by hand cleaning apparatus 100. For example, the information regarding the person may be incorporated into the magnetic information stored on a magnetically readable card dispensed by hand cleaning apparatus 100 or printed on an authorization badge. Information regarding when the person must leave the building, or portion of the building, when the person must clean their hands again, or the portions of the building that a person may access may be stored in a machine readable manner and/or visually displayed.

In a further alternate embodiment, it will be appreciated that microphone 132 need not to be connected to a hard drive recorder but may be connected to a speaker in a control room in the building or elsewhere.

The forgoing is a description of the preferred embodiments of the invention, which is given here by way of example only. The invention is not be taken as limited to any of the specific features as described, but comprehends all such variations thereof as come within the scope of the appended claims. In particular, it will be appreciated that the various features set out herein may be combined in any particular combination or sub combination.

1. An apparatus comprising:
a) a hand cleaning apparatus;
b) an output module enabling entry to a building or portion of a building; and,
c) a controller connected to the hand cleaning apparatus and the output module, the controller actuating the output module subsequent to activation of the hand cleaning apparatus.

2. The apparatus as claimed in claim 1 wherein the building is selected from the group consisting of a hospital, a nursing home, a medical clinic, a government building and a public building, the apparatus is positioned outside the building or the portion of the building or at the entrance to a building and the output module is operatively connected to open or permit opening of a barrier to entry of the building or the portion of the building upon a positive signal being issued by the controller.

3. The apparatus as claimed in claim 2 wherein the output module provides a member upon a positive signal being issued by the controller.

4. The apparatus as claimed in claim 3 wherein member comprises an access card that is readable by a card reader and the card reader is operatively connected to open the barrier to entry of the building.

5. The apparatus as claimed in claim 3 wherein the member comprises an authorization badge, which visually displays information.

6. The apparatus as claimed in claim 1 wherein the output module includes a mask and/or glove dispenser, whereby upon a positive signal being issued by the controller, the output module dispenses one or both of gloves and a mask.

7. The apparatus as claimed in claim 1 further comprising a signaling member whereby upon a negative signal being issued by the controller, the signaling member issues a warning signal to a user.

8. The apparatus as claimed in claim 1 further comprising a signaling member whereby upon a negative signal being issued by the controller, the signaling member issues a warning signal to building security.

9. The apparatus as claimed in claim 1 further comprising a hand cleaning sensor and the controller actuates the output module upon receiving a positive signal from the hand cleaning sensor.

10. The apparatus as claimed in claim 9 wherein the hand-cleaning sensor monitors the position of the hands of a user.

11. The apparatus as claimed in claim 9 wherein the hand-cleaning sensor monitors that a user has completed a hand cleaning cycle correctly.

12. The apparatus as claimed in claim 1 wherein the hand cleaning apparatus operates a cleaning cycle and the controller actuates the output module after correct completion of the cleaning cycle.

13. The apparatus as claimed in claim 1 wherein the hand cleaning apparatus operates a cleaning cycle and the controller actuates the output module after completion of the cleaning cycle.

14. The apparatus as claimed in claim 1 further comprising a health sensor to check the health of a user.

15. The apparatus as claimed in claim 14 wherein the health sensor uses the temperature of a user to determine whether the user may be sick.

16. The apparatus as claimed in claim 14 further comprising a signaling member wherein the health sensor causes the signaling member to issue a warning signal if the health sensor determines that a user may be sick.

17. The apparatus as claimed in claim 14 wherein, upon determining that a user may be sick, the health sensor sends a signal preventing the actuation of the output module.

18. The, apparatus as claimed in claim 1 further comprising an input member whereby a person enters identifying information.

19. The apparatus as claimed in claim 18 wherein the input member comprises a card reader and/or a keyboard.

20. The apparatus as claimed in claim 18 wherein the output module comprises an access card dispenser or an authorization badge dispenser and at least some of the identifying information is provided on an access card or authorization badge dispensed by the apparatus.

21. The apparatus as claimed in claim 5 wherein the badge has a signaling member to signal a warning when a person needs to again clean their hands.

22. The apparatus as claimed in claim 3 wherein the member is coded to authorize entrance to one or more potions of the building and/or to authorize entrance to a building or one or more portions of the building for a specified period of time.

23. An apparatus comprising:
a) a hand cleaning apparatus;
b) a hand cleaning sensor; and,
c) a mask and/or glove dispenser, whereby upon a positive signal being issued by the hand-cleaning sensor, the output module dispenses one or both of gloves and a mask.

24. The apparatus as claimed in claim 23 further comprising a signaling member whereby upon a negative signal being issued by the hand-cleaning sensor, the signaling member issues a warning signal to a user.

25. The apparatus as claimed in claim 23 further comprising a signaling member whereby upon a negative signal being issued by the hand-cleaning sensor, the signaling member issues a warning signal to building security staff.

26. The apparatus as claimed in claim 23 further comprising a health sensor to check the health of a user.

27. The apparatus as claimed in claim 23 wherein the health sensor uses the temperature of a user to determine whether the user may be sick.

28. An apparatus comprising:
a) a hand cleaning apparatus;
b) a hand cleaning sensor; and,
c) a health sensor to check the health of a user.

29. The apparatus as claimed in claim 28 further comprising a signaling member whereby upon a negative signal being issued by the hand cleaning sensor, the signaling member issues a warning signal to a user.

30. The apparatus as claimed in claim 28 further comprising a signaling member whereby upon a negative signal being issued by the hand-cleaning sensor, the signaling member issues a warning signal to building security staff.

31. The apparatus as claimed in claim 28 further comprising a signaling member whereby upon a negative signal being issued by the health sensor, the signaling member issues a warning signal to a user.

32. The apparatus as claimed in claim 28 further comprising a signaling member whereby upon a negative signal being issued by the hand-cleaning sensor, the signaling member issues a warning signal to building security.

33. The apparatus as claimed in claim 28 wherein the health sensor uses the temperature of a user to determine whether the user may be sick.

34. A method for controlling access to a building or a portion of the building using a hand cleaning apparatus, the method comprising:
a) positioning the hand cleaning apparatus proximate to a barrier to entry of the building of the portion of the building; and,
b) using a dispenser apparatus to automatically provide one or more of an access card and an authorization badge to a person after the hand cleaning apparatus is actuated.

35. The method of claim 34 wherein the building or the portion of the building has a barrier to entry that is controlled by a card reader and the method further comprises using the access card to open the barrier to entry.

36. The method of claim 34 further comprising requiring the person to show the authorization badge prior to entering the building or the portion of the building.

37. The method of claim 34 further comprising providing a health sensor that automatically checks the health of a person and preventing the person from entering the building or the portion of the building if the health sensor determines that the person may be sick.

38. The method of claim 34 further comprising providing a mask and/or glove dispenser, whereby mask and/or glove dispenser dispenses one or both of gloves and a mask after the person uses the hand cleaning apparatus.

39. The method of claim 34 further comprising requiring the person to enter identifying information prior to the dispenser operating.

40. The method of claim 34 wherein at least some of the identifying information is provided on the card or badge dispensed by the dispenser.

41. The method of claim 34 wherein the hand cleaning apparatus operates a cleaning cycle and the dispenser apparatus is actuated after completion of the cleaning cycle.

42. The apparatus as claimed in claim 34 wherein the badge is coded to authorize entrance to one or more portions of the building and/or to authorize entrance to a building or one or more portions of the building for a specified period of time.

43. A method for controlling access to a building or a portion of the building using a hand cleaning apparatus wherein the building or the portion of the building has a barrier to entry that is mechanically controlled by a motor, the method comprising:
a) positioning the hand cleaning apparatus proximate to the barrier to entry of the building of the portion of the building; and,
b) operatively connecting the hand cleaning apparatus to the barrier to entry whereby the barrier to entry is configured to permit entry after the person uses the hand cleaning apparatus.

44. The method of claim 43 further comprising providing a health sensor that automatically checks the health of a person and preventing the person from entering the building or the portion of the building if the health sensor determines that the person may be sick.

45. The method of claim 43 further comprising providing a mask and/or glove dispenser, whereby mask and/or glove dispenser dispenses one or both of gloves and a mask after the person uses the hand cleaning apparatus.

46. The method of claim 43 further comprising requiring the person to enter identifying information prior to the dispenser operating.

47. The method of claim 43 further comprising providing one or more of an access card and an authorization badge to the person after the person uses the hand cleaning apparatus.

48. The method of claim 46 further comprising requiring the person to enter identifying information prior to the dispenser operating wherein at least some of the identifying information is provided on the card or badge provided to the person.
